(19) United States
(12) Patent Application Publication
(10) Pub. No.: US 2008/0008478 A1
(43) Pub. Date: Jan. 10, 2008

(54) Transmitting device for optical signals

(75) Inventors: Martin Theis, Aalen (DE); Rolf Sand, Oberkochen (DE); Dietmar Gaengler, Langenau (DE); Carsten Schymik, Aalen (DE)

Correspondence Address: WELLS ST. JOHN P.S., 601 W. FIRST AVENUE, SUITE 1300, SPOKANE, WA, 99201, US

(73) Assignee: Carl Zeiss Optronics GmbH

(21) Appl. No.: 11/809,820

(22) Filed: Jun. 1, 2007

(30) Foreign Application Priority Data
Jun. 29, 2006 (DE) 10 2006 030 421.7

(51) Int. Cl. H04B 10/04

(52) U.S. Cl. 398/182

(57) ABSTRACT

The invention relates to a transmitting device for optical signals, having an optical transmitting unit and at least one optical assembly for conditioning a light beam emitted by the transmitting unit. Here, the device has means which permit the attenuation of the intensity of the light beam in the region of an optical axis of the device.

### CROSS REFERENCE TO RELATED APPLICATION

This patent application relates to and claims priority to corresponding German Patent Application No. 10 2006 030 421.7, which was filed on Jun. 29, 2006, and which is incorporated by reference herein.

### BACKGROUND OF THE INVENTION

1. Field of the Invention

The invention relates to a transmitting device, in particular sending and receiving optical signals. A widespread possibility for transmitting signals over large distances is to transmit an optical signal in free space from a transmitting unit via at least one optical assembly to a receiving unit at a distance from the transmitting unit, where the incoming light is directed, by way of at least one further optical assembly, to a receiver and detected. It is an advantage of using optical signals that a transmission with significantly higher data rates can be realized on account of the small wavelength of the optical radiation and the associated high frequency as compared to, for example, radio waves. Furthermore, the propagation characteristics of the optical radiation used, whose wavelength usually lies in the near infrared, ensure small deflection of the transmission beam used for transmission and thus the realization of a relatively robust communication connection.

2. Description of the Related Art

Optical assemblies, such as for example collimators, eyepieces and telescopes, which the light beam traverses on its way to the free-optical transmission link, are commonly used for conditioning purposes, that is to say for shaping and deflecting the optical radiation emitted by the respective transmitting unit. Since the devices used for transmitting optical signals generally have both a transmitting and a receiving unit, a conventional measure is to use individual optical assemblies, such as for example a telescope, both for the transmitting unit for beam conditioning purposes, and for the receiving unit for the purpose of focusing the received light beam. However, this measure entails the problem that, during a simultaneous transmitting and receiving operation of the device, back reflections occur in the assemblies used, in particular at their interfaces, which back reflections reach the particular receiving unit of the currently sending device and have a disturbing effect there. This problem is usually countered by antireflectioncoating of the interfaces of the optical elements used, i.e. by providing them with reflection-reducing layers which can be used to substantially reduce the intensity of the resulting back reflections. In particular in the case of an intended transmission over long distances, for example in the region of several thousand kilometres as, for example, in the case of a connection between two satellites in space, the problem which was mentioned is exacerbated, however, by the fact that the signals to be received reach the receiving unit only in a strongly attenuated form and the intensity of the undesired back reflections is thus of the order of magnitude of the intensity of the desired signals to be received. Said effect can thus not be suppressed with sufficient effectiveness by virtue of the antireflectioncoating of the optical elements alone.

### SUMMARY OF THE INVENTION

It is therefore an object of the present invention to provide a transmitting device for optical signals, in which the abovementioned disturbing back reflections are suppressed effectively.

This object is achieved by the device with the features indicated in claim 1; the subclaims relate to advantageous developments and variants of the invention.

The transmitting device for optical signals according to the invention discloses an optical transmitting unit and at least one optical assembly for conditioning a light beam emitted by the transmitting unit. In this case, the device has means which permit the attenuation of the intensity of the light beam in the region of an optical axis of the device. In other words, the emitted light beam is dimmed in its central region. The optical elements used have interfaces, which run essentially orthogonally to the optical axis, in this region in particular, i.e. near the optical axis of the device. Back reflections produced at the interfaces in this region would therefore be reflected back practically directly into the receiver, as long as the relevant optical elements in the device are operated both in the transmission and in the receiving direction. The attenuation of the intensity of the light beam in the region of the optical axis thus has the advantage that especially those regions of the light beam emitted by the transmitting unit which exhibit the highest potential for producing disturbing back reflections are hidden.

The degree of attenuation of the intensity of the light beam in the region of the optical axis can differ. In particular, the intensity of the light beam in the region of the optical axis can be attenuated to such an extent that the light intensity in the regions of the light beam which are near the optical axis is lower than the intensity in the regions of the light beam which are further away from the optical axis. It is also conceivable in principle to attenuate the intensity in the regions in the optical axis with respect to the intensity emitted by the light source without the light intensity near the optical axis being necessarily lower than the intensity in the regions further away from the optical axis. The latter case can occur, by way of example, if the transmitting unit emits a light beam with a Gaussian intensity profile in the radial direction—flattening of the Gaussian intensity profile near the maximum of the Gaussian curve and thus near the optical axis would also have the desired effect in principle.

In a first advantageous variant of the invention, one of said optical assemblies for conditioning the light beam emitted by the transmitting unit is formed by a collimator. The mode of action of the collimator is such that it uses an arrangement of several lenses as optical elements to widen the light beam , usually exiting a transmission fibre and to produce a parallel light bundle with a defined diameter and generally a Gaussian intensity profile. It is now an effective possibility for attenuating the intensity of the light beam in the region of the optical axis of the collimator for the optical elements or at least one of the optical elements of the collimator to be provided, in the region of the optical axis, with a reflecting layer as a means for attenuating the intensity of the light beam traversing the collimator such that the intensity of the light beam in the region of the optical axis of the collimator is reduced by reflection. Here, advantage is taken of the fact that the collimator is located only in the transmission path of the transmitting device for optical signals such that the back reflections produced by the reflecting layer merely fall back to the transmitting unit without producing any disturbing effects. In this manner, it is possible for the intensity of the light beam to be attenuated even before it enters the optical assemblies located in the receiving section of the device. As an alternative or in addition to this, provision may also be made to choose the transmission fibre in a manner such that the light guided within it is such that, in terms of its mode structure, the light beam already shows the desired radial intensity characteristic when it exits the transmission fibre. This can also be supported by the use of a correspondingly chosen light source with a matched mode structure, for example a vertically emitting semiconductor laser (VCSEL). As an alternative or in addition to this, it is possible to change the intensity distribution of the light in the collimator using a diffractive element (DOE) in a manner such that merely an annular illumination is produced. This measure has the advantage that it causes the entire intensity radiated in to be attenuated to a lesser extent than is caused by reflection at reflecting layers.

In order to achieve the desired effect in the optical assemblies of the device used to condition the emitted light beam and also to focus the received light beam, other measures are necessary, since a reflection in the direction of the receiving unit must be avoided in these assemblies at all costs. An example of an advantageous procedure for this purpose is, in the case where a transmitting/receiving telescope with eyepiece is used, the arrangement of a light-absorbing optical element as a means for attenuating the intensity of the light beam in the region of the optical axis of at least one of the optical elements of the eyepiece. Advantageously, a so-called light trap can be used as light-absorbing element. A light trap is an optical assembly in which incident light is attenuated particularly effectively by reflection at or absorption by prisms/cones which are arranged at specific angles with respect to one another. A simple variant which is suitable is the blackening of said regions of the optical elements; in this case, however, the risk of back reflection of scattered light in the direction of the receiving unit is comparatively higher.

The upstream attenuation of the intensity of the light beam in the collimator has the effect here that damage to the light trap or the occurrence of thermal stresses is avoided since a large portion of the intensity of the light emitted by the transmitting unit does not reach the light trap and therefore does not need to be absorbed by it.

An exemplary embodiment of the invention is explained below by way of example with reference to the single FIG. 1.

### BRIEF DESCRIPTION OF THE DRAWING

FIG. 1 shows an exemplary transmitting device for optical signals, having an optical transmitting unit 1, a collimator 2 as optical assembly for conditioning a light beam 12 emitted by the transmitting unit 1, a deflection mirror 3 and a polarization splitter 4. The transmitting device for optical signals also has the second deflection mirror 5, the eyepiece 6 and the Cassegrain telescope 9 with the two mirrors 8 and 7.

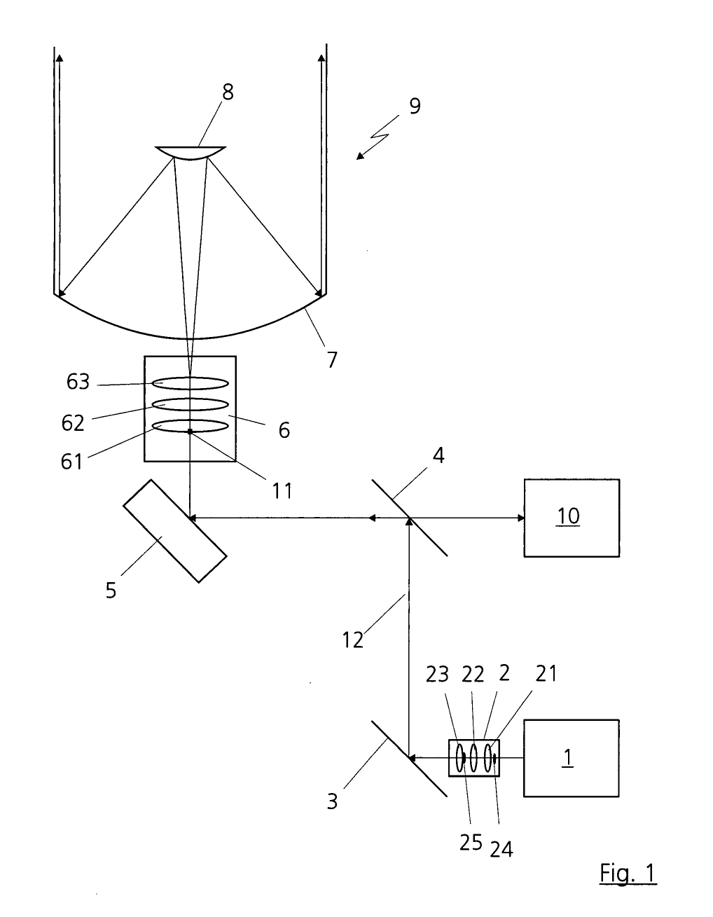

### DETAILED DESCRIPTION

In a Cassegrain telescope, the incident light initially strikes a concave- parabolic main mirror (in the present example the first telescope mirror 7). The latter reflects the light to a convex-hyperbolic secondary mirror (in the present example to the second telescope mirror 8). The latter is arranged such that its concave focal point coincides with that of the first telescope mirror 7. The convex focal point points in the direction of the first telescope mirror 7. The second telescope mirror 8 here extends the focal length and permits a compact configuration of the arrangement.

The device shown contains a receiving unit 10 for the reception of radiation incident via the telescope 9. During the operation of the device illustrated, the optical transmitting unit 1, for example a semiconductor laser, transmits with an emission wavelength of approximately 1064 nm and a power of approximately 2 W. Other emission wavelengths suitable for the respective application are, of course, also conceivable, in particular 1550 nm. The emitted light beam 12 first enters the collimator 2 with the lenses 21, 22, 23, in which it is widened to a diameter of approximately 12 mm. The intensity of the light beam 12 in the region of the optical axis is already attenuated in the collimator 2. To this end, the diffractive element 24, which can, for example, be in the form of a diffraction grating, is located upstream of the lens 21 in the beam path of the collimator 2. Diffraction at the diffractive element 24 causes the intensity of the light beam 12 to be deflected from the regions in the vicinity of the optical axis to regions further away from the axis.

The optical element 23, which has in the region of its optical axis the reflective layer 25, which reflects back the light in the central region of the light beam 12 emitted by the transmitting unit 1 in the direction of the transmitting unit 1, is located in the further beam path through the collimator 2. In this part of the arrangement, reflection is non-critical because the light reflected at the reflective layer 25 cannot reach the receiving unit 10 and thus does not lead to disturbances either. It is, of course, also conceivable for the reflective layer 25 to be arranged on one of the other lenses 21 or 22 arranged in the collimator 2. It is important only that the light beam 12 leaving the collimator 2 is attenuated in its region closest to the optical axis of the device. The region in which the light beam 12 is attenuated can have a diameter of approximately 2 mm.

After the light beam 12 exits the collimator 2, it reaches the deflection mirror 3 where it is deflected in the direction of the polarization splitter 4. The polarization splitter 4 has polarization-dependent reflection characteristics, i.e. light incident on it is either reflected or transmitted, i.e. allowed through in the direction of the receiver 10, as a function of its polarization with respect to the plane of incidence. In the present example, the light beam 12 emitted by the transmitting unit 1 is linearly polarized in a manner such that, after it has passed through the collimator 2 and been deflected at the deflection mirror 3, it is completely reflected at the polarization splitter 4 in the direction of the second deflection mirror 5. The second deflection mirror 5 deflects the light beam 12 in the direction of the eyepiece 6 of the Cassegrain telescope 9. In the present example, the eyepiece 6 has the lenses 61, 62 and 63, with the first lens 61 in the direction of the light beam 12 being provided, in the region of its optical axis, with the light trap 11, in which light incident in this region is nearly completely absorbed. The particular advantage of the configuration illustrated lies in the fact that the light trap 11 is located in the first lens 61 in the beam direction. This has the effect that, even before further optionally reflecting interfaces in the eyepiece 6 are reached, the intensity of the incident light beam 12 in the region of its optical axis is effectively attenuated further. It can be advantageous, however, to provide a further light trap in the path of the eyepiece, for example in the lens 63, in order to further reduce the probability of back reflections stemming from light beams with non-parallel axes. The light traps can in this case have a diameter in the region of approximately 2 mm. After the light beam 12 conditioned in this manner leaves the eyepiece 6, it enters the Cassegrain telescope 9 through an opening in the first mirror 7 of said Cassegrain telescope 9, is reflected back at the second mirror 8 of the Cassegrain telescope 9 in the direction of the first mirror 7 of the Cassegrain telescope 9 and leaves the telescope 9 as a widened, approximately parallel light bundle in the direction of a transmitting/receiving device (not illustrated), which is intended to be used to exchange data.

An incident light beam (not illustrated) emitted by the transmitting/receiving device (likewise not illustrated) conversely initially strikes the first mirror 7 of the Cassegrain telescope 9, from where it is deflected to the second mirror 8 of the Cassegrain telescope 9 and subsequently reaches the polarization splitter 4 via the eyepiece 6 and the deflection mirror 5. The polarization of the incident light beam is chosen here such that the light beam passes through the polarization splitter 4 and subsequently reaches the receiving unit 10, where it is detected. On account of the small extent, with respect to the diameter of the light beam to be received, of the light traps 11 used for the attenuation of the intensity of the light beam in the region of the optical axis, the intensity of the desired light to be received, which reaches the receiving unit 10, is not substantially reduced.

A particular advantage of the arrangement illustrated lies in the fact that the attenuation of the intensity of the light beam 12 in the region of the optical axis is achieved by combining different elements, with the result that disturbances of the receiving unit 10 by back-reflected false light are effectively avoided.

1. Transmitting device for optical signals, having comprising:
an optical transmitting unit; and
at least one optical assembly for conditioning a light beam emitted by the transmitting unit, wherein the device has means for the attenuation of the intensity of the light beam in the region of an optical axis of the device.

2. Device according to claim 1, wherein the device has a collimator for beam widening purposes as optical assembly in the direction of said light beam emitted by said transmitting unit.

3. Device according to claim 1, wherein the device has an eyepiece in the direction of said light beam emitted by said transmitting unit.

4. Device according to claim 2, wherein a means for the attenuation of the intensity of said light beam is a reflecting layer in the region of the optical axis of at least one optical element of said collimator.

5. Device according to claim 3, wherein a means for the attenuation of the intensity of said light beam is a light-absorbing optical element in the region of the optical axis of at least one optical element of said eyepiece.

6. Device according to claim 5, wherein said light-absorbing element is a light trap.

7. Device according to claim 2, wherein said collimator is designed such that, after said light beam has passed through said collimator, it has a diameter of approximately 12 mm.

8. Device according to claim 2, wherein the means for the attenuation of the intensity of said light beam are designed such that, after said light beam has passed through said collimator, it is attenuated in a region of approximately 1 mm around the optical axis.

9. Device according to claim 1, wherein said optical transmitting unit emits light with a wavelength of approximately 1064 nm or of approximately 1550 nm.

10. Device according to claim 1, wherein one optical assembly is a telescope, in particular a Cassegrain telescope.

11. Device according to claim 1, wherein said means for the attenuation of the intensity of said light beam is a diffractive optical element.

12. Device according to claim 1, wherein said means for the attenuation of the intensity of said light beam are designed such that the intensity of the attenuated light beam in the region of the optical axis is lower than the intensity in the regions which are further away from the optical axis in the axial direction.

13. Device according to claim 1, wherein the device comprises a receiving unit and in that a beam splitter is present which divides the light paths in the device into:
a first partial light path which is traversed only by light emitted by the transmitting unit,
a second partial light path which is traversed only by light to be received by the receiving unit, and
and a third partial light path which is traversed both by light to be received by the receiving unit and by light emitted by the transmitting unit, with means for the attenuation of the intensity of said light beam being located in the first partial light path.
